(19) United States
(12) Patent Application Publication
(10) Pub. No.: US 2012/0325158 A1
(43) Pub. Date: Dec. 27, 2012

(54) PET STATION

(76) Inventor: Jeffrey T. Holman, Farmington, UT (US)

(21) Appl. No.: 13/532,491

(22) Filed: Jun. 25, 2012

Related U.S. Application Data
(60) Provisional application No. 61/500,504, filed on Jun. 23, 2011.

(51) Int. Cl. A01K 5/00; A01K 5/01; A47B 96/00

(52) U.S. Cl. 119/61.54; 312/249.8; 119/61.57

(57) ABSTRACT

Embodiments of a portable and modular pet station include a mobile storage cabinet, an exterior surface, and a feeding unit. The mobile storage cabinet has at least one opening to access an interior storage space within the storage cabinet. The mobile storage cabinet has a plurality of wheels to facilitate movement of the mobile storage cabinet on an underlying surface. The exterior surface of at least one panel of the storage cabinet provides a mounting surface. The feeding unit is attached to the mounting surface of the exterior surface of the storage cabinet. The feeding unit includes at least one structural member to retain food in an accessible arrangement for access by an animal.

### CROSS-REFERENCE TO RELATED APPLICATIONS

This application claims the benefit of U.S. Provisional Application No. 61/500,504, filed on Jun. 23, 2011, which is incorporated by reference herein in its entirety.

### SUMMARY

Embodiments of a portable pet station are described. In one embodiment, the pet station includes a mobile storage cabinet with at least one opening to access an interior storage space within the storage cabinet. The mobile storage cabinet has a plurality of wheels to facilitate movement of the mobile storage cabinet on an underlying surface. The pet station also includes an exterior surface of at least one panel of the storage cabinet. The exterior surface provides a mounting surface. The pet station also includes a feeding unit attached to the mounting surface of the exterior surface of the storage cabinet. The feeding unit includes at least one structural member to retain food in an accessible arrangement for access by an animal.

Embodiments of a pet feeding station are also described. In one embodiment, the pet feeding station includes a vertical mounting support structure, a feeding container, and a spill retention container. The feeding container is configured to couple to the vertical mounting support structure at a height to maintain the feeding container above and off of an underlying surface. The spill retention container is configured to couple to the vertical mounting support structure below the feeding container. The spill retention container is configured to catch substances that spill from the feeding container to substantially prevent the substances that spill from the feeding container from depositing on the underlying surface.

Embodiments of a modular pet station attached to a wall are also described. In one embodiment, the modular pet station includes a plurality of receiving units. Each receiving unit is configured to mate with a corresponding mounting structure. The modular pet station also includes a feeding unit with a unit mounting structure configured to attach to at least one of the plurality of receiving units. The modular pet station also includes a storage space to store pet supplies.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 discloses a schematic diagram of one embodiment of a modular pet station with a wall attachment.

FIG. 2 discloses a schematic diagram of one embodiment of a modular pet station with multiple storage spaces.

FIG. 3 discloses a schematic diagram of one embodiment of a portable pet station.

FIG. 4 discloses a side-view of one embodiment of a portable pet station with a retractable feeding unit.

FIG. 5 discloses a side-view of one embodiment of a portable pet station with a retractable feeding unit.

FIG. 6 discloses a side-view of one embodiment of a portable pet station with a debris catching unit.

FIG. 7 discloses a side-view of one embodiment of a portable pet station with a debris catching unit and a hood positioned over the debris catching unit.

FIG. 8 discloses a schematic view of one embodiment of a debris catching apparatus.

FIG. 9 discloses a side-view of one embodiment of a debris catching apparatus.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments include a storage space for storage of pet supplies. In this description, references to a “storage space” may refer to any structure that may store or hold pet supplies, such as a drawer, box, or other attachment to a pet station.

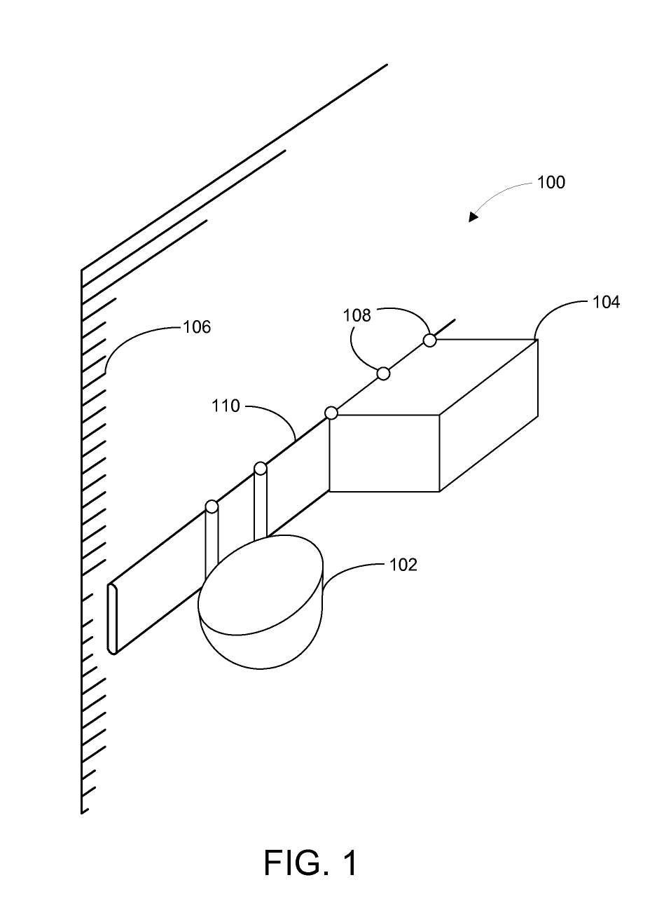

FIG. 1 discloses a schematic diagram of one embodiment of a pet station 100. The pet station 100 includes a feeding unit 102 and/or storage unit 104 that is suspended from a wall attachment 110 that is fixed to a wall 106. The feeding unit 102 and/or storage unit 104 may be attached to the wall attachment 110 at one or more attachment points 108. The station 100 may include a plurality of wall attachments 110 at different vertical levels on the wall 106 to increase the number of items that may be attached to the pet station 100. The feeding unit 102 may be a food bowl, a water dispenser, or other device for providing food or water to a pet. Further, multiple feeding units 102 or storage units 104 may be attached to a single wall attachment 110 or dispersed between multiple wall attachments 110 to accommodate multiple pets of similar or diverse sizes.

While the illustrated embodiment discloses a wall attachment 110 as an intermediary between the different attachments 102, 104 and a wall 106, the different attachments 102, 104 may be attached to a wall attachment 110 or directly to the wall 106 at one or more connection points 108. These connection points 108 may be points 108 along a recess in the wall 106 for hooking attachments 102, 104 to the wall. The attachment points 108 may also be a variety of holes at different horizontal and vertical points on the wall for inserting hooks, clips, or other forms of attachment mechanisms that may be used for holding and/or supporting various attachments 102, 104 for a variety of purposes.

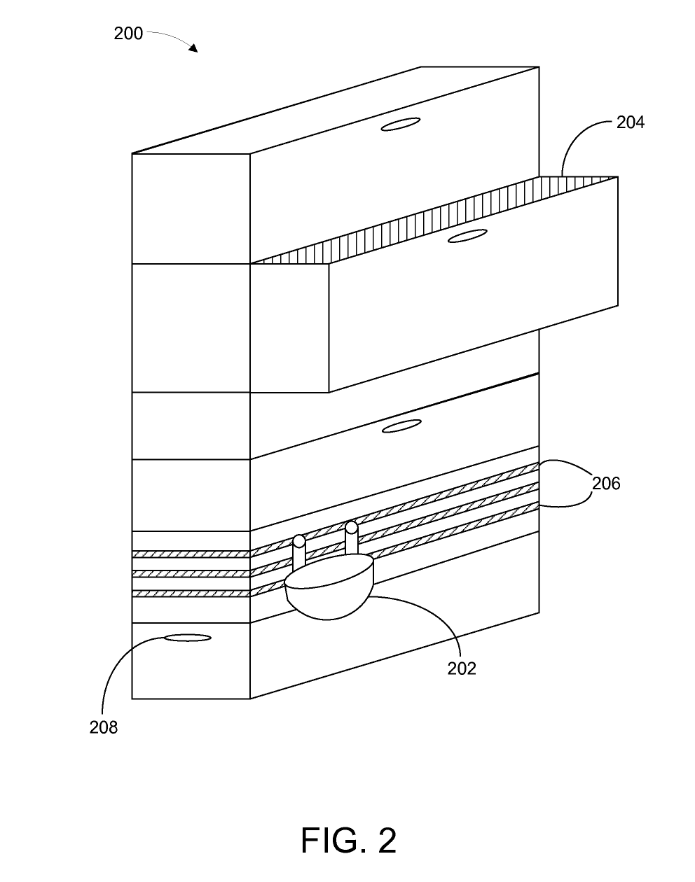

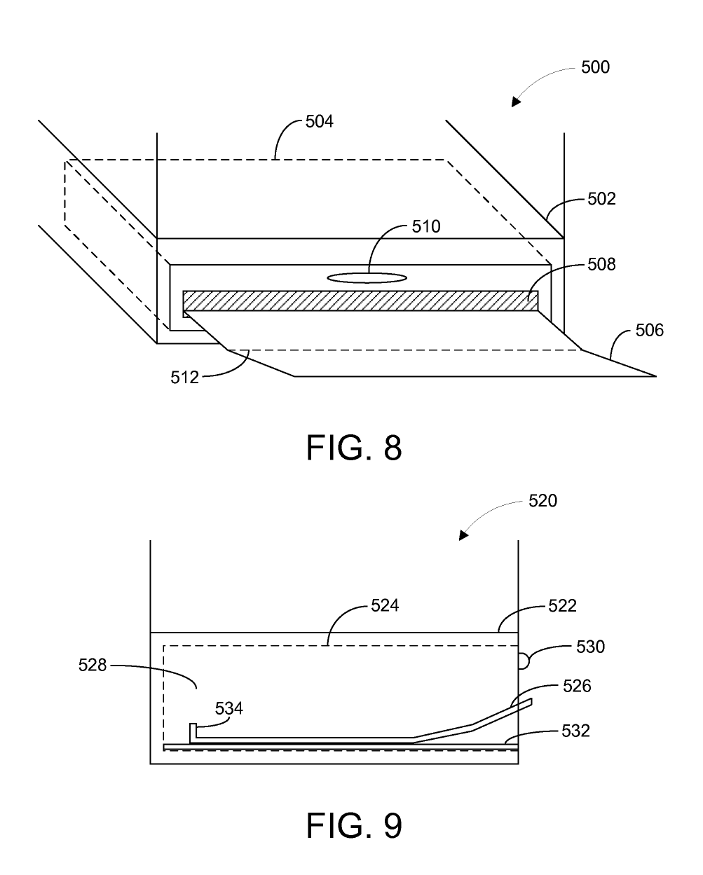

FIG. 2 discloses a schematic diagram on one embodiment of a pet station 200. The entire station 200 may be attached to a wall 106 or may be a stand-alone unit, as illustrated in FIG. 2. The pet station 200 may include one or more feeding units 202 attached to a plurality of recessions 206 at one or more connection points. The feeding unit 202 and connection points may share similar characteristics to the attachment units 102, 104 and connection points 108 discussed in relation to FIG. 1. The station 200 further includes a plurality of front 204 or side drawers 208 for storing different pet supplies, such as food, toys, and other objects. A bottom drawer 208 may also function as a waste disposal system, which will be discussed in greater detail with regards to FIG. 8.

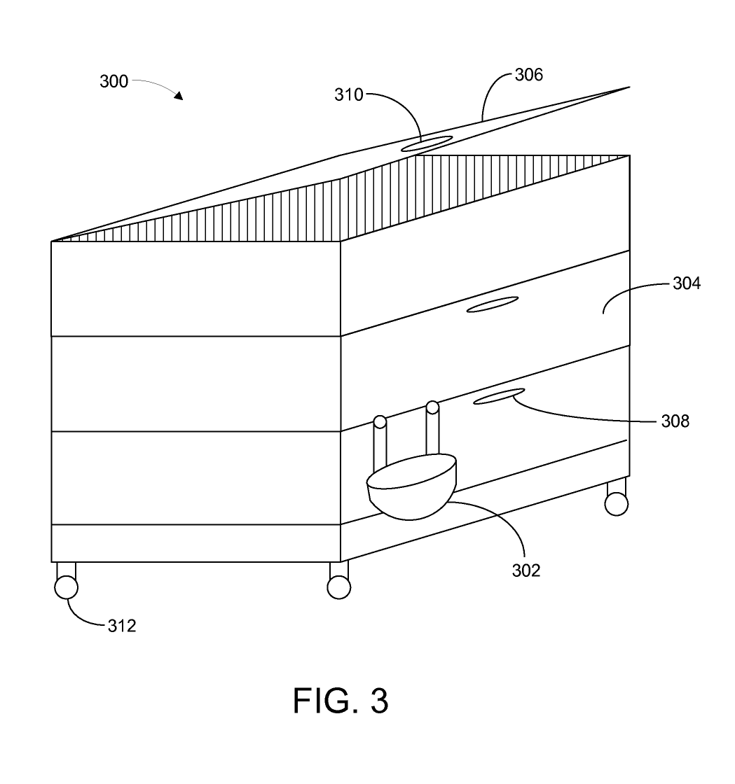

FIG. 3 discloses a schematic diagram of one embodiment of a portable pet station 300. The station 300 includes a feeding unit 302 or other attachment that may be attached to the station at one or more connection points. The feeding unit 302 and attachment points may share similar characteristics to features discussed in relation to FIGS. 1 and 2. The pet station 200 may further include a plurality of drawers 304, 306 for storing different pet supplies. The drawers 304, 306 may be opened by pulling a handle 308 and opening a drawer 304 from the front and/or lifting a handle 310 and opening a drawer from the top 306. Further, the pet station 300 includes a plurality of wheels 312 attached to the base of the pet station 300 to enhance the portability of the station 300 and accommodate different spaces or environments.

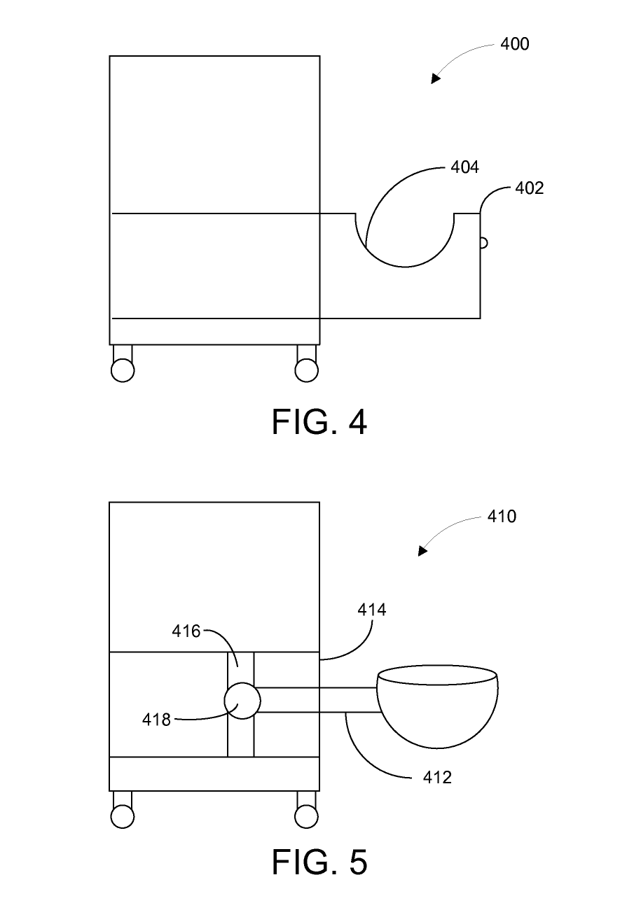

FIG. 4 discloses a side-view of one embodiment of a portable pet station 400. The pet station 400 includes a feeding unit 404 that is part of a retractable drawer 402. The retractable drawer 402 may be located at a higher or lower location, depending on the size of the pet, or may include multiple drawers with built in feeding units. Further, the drawer 402 may be removed and reinserted to the pet station 400 for cleaning and/or maintenance purposes.

FIG. 5 discloses a side-view of one embodiment of a portable pet station 410. The pet station 400 includes a feeding unit that is retracted from a drawer or drawer space 414. The feeding unit is connected to the drawer 414 by an extended horizontal support 412 which is connected to a vertical support 416 at a connection or pivot point 418. The horizontal support 412 may be configured to adjust in height to accommodate a variety of pets by sliding the horizontal support 412 up or down in relation to the vertical support 416. Also, the connection point 418 may pivot in different directions allowing the feeding unit to adjust vertically or horizontally with or without sliding the horizontal support 412 up or down the vertical support 416. In other embodiments, another connection or pivot point may be located outward from the vertical support 416 along the horizontal support 412, thereby creating multiple connection or pivot points, allowing greater flexibility and/or allowing for multiple feeding units to extend from the same drawer 414. Similar to the feeding unit of FIG. 4, the feeding unit may also slide in or out of the drawer 414 by sliding the vertical support 416 horizontally inward or outward from the pet station 400. Also, the feeding unit, individually or together with other parts of the drawer 414, may be removed and reinserted for cleaning and/or maintenance purposes.

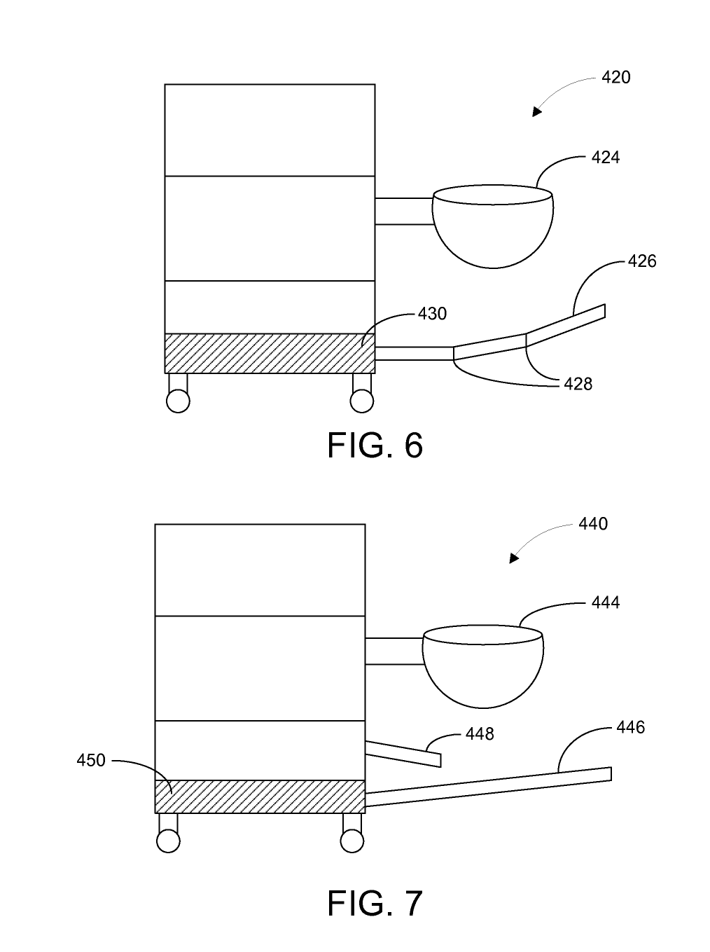

FIG. 6 discloses a side-view of one embodiment of a portable pet station 420. The pet station 420 includes a feeding unit 424, which may share many of the same qualities as the feeding unit described in relation to other embodiments. Additionally, the pet station 420 may include a debris catching device 426 for any food or debris. The debris catching device 426 may be placed, for example, below the feeding unit 424 for catching food or debris that falls from the feeding unit 426 while it is being used by a pet or other user. The debris catching unit 426 may be retractable to slide in or out of a space 430 of the pet station 420. The debris catching unit 426 may have folding points 428 allowing the catching unit 426 to fold up and conveniently fit into the pet station 420. While the space 430 may be used to store the catching unit 426, it may also be used to receive any debris or waste that falls from the feeding unit 424, to be stored away for later disposal. This would ensure that excess food or waste does not accumulate on the floor around the pet station 420, and would prevent a constant need for cleaning around the base of the station 420. The space 430 could then be cleaned at the owner's convenience in an efficient manner. Alternatively, the space 430 could include a drawer apparatus for removal and maintenance purposes, described in more detail with regards to FIG. 8. Any internal storage spaced located above the space 430 may be separated from the space 430 by a bottom panel which acts as a partition and support for items stored within the upper storage space.

FIG. 7 discloses a side-view of one embodiment of a portable pet station 440. The pet station 440 includes a feeding unit 444 that may share many of the same features as feeding units described in relation to other embodiments. The feeding unit 444 may be positioned over a debris catching unit 446. The debris catching unit 446 may be a straight and/or retractable unit, and may share similar features to the debris catching unit discussed in relation to FIG. 6. Waste or debris may be directed to and collected into a space 450 for later disposal, and may additionally include a hood 448 positioned above the debris catching unit 446. The hood 448 creates a shield for the opening to the otherwise enclosed space 450, allowing access for debris or waste to enter the space 450, while making access to the opening restricted from pets, children, pests, or other animals that may try to eat or extract waste from the space 450.

FIG. 8 discloses a schematic view of one embodiment of a debris catching apparatus 500 that may be used in conjunction with certain embodiments of the pet station, for example, as a drawer or wall attachment. The apparatus 500 includes a drawer frame 502 wherein a drawer 504 with a handle 510 may be conveniently inserted or withdrawn from the apparatus 500. The drawer 504, including parts within, may be withdrawn for maintenance or other purposes, and creates a convenient way for owners of the apparatus 500 to clean the drawer 504 or its discrete components. The drawer 504 includes a debris catching tray 506 for catching food or other waste, possibly falling from a feeding unit. The tray 506 may be retractable in or out of the drawer 504 or may include folding points 512 for folding the tray 506 and fitting more conveniently into the drawer 504. Within the drawer 504 is an enclosed space 528 accessible at an opening 508, through which food or other debris is directed as it falls onto the debris catching tray 506.

FIG. 9 discloses a side-view of one embodiment of a debris catching apparatus 520. The apparatus 520 includes a drawer frame 522 wherein a drawer 524 with a handle 530 may be conveniently inserted or withdrawn from the apparatus 520. In the illustrated embodiment, the drawer 524 includes a debris catching tray 526 that may slide in or out of the drawer 524. The tray 526 directs excess debris or waste that may fall from a feeding unit into an enclosed space 528 accessible at an opening 508, through which food or other debris is directed. The tray 526 may include a lip 534 located on the back and/or front of the tray 526 for decreasing the amount of debris that falls from the tray 526. The tray 524 may move horizontally along a sliding mechanism 532 that may allow for the tray 526 to conveniently slide in or out of an opening 508 of the drawer 524. The sliding mechanism 532 may utilize a variety of tools, such as bearings, rails, wheels, tracks and/or other devices for sliding the tray 526 in and out of the drawer 524 in a convenient way. The tray 526 may further be removed individually or together with the drawer 524 for cleaning and maintenance purposes.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A portable pet station comprising:
a mobile storage cabinet with at least one opening to access an interior storage space within the storage cabinet, wherein the mobile storage cabinet has a plurality of wheels to facilitate movement of the mobile storage cabinet on an underlying surface;
an exterior surface of at least one panel of the storage cabinet, the exterior surface providing a mounting surface; and
a feeding unit attached to the mounting surface of the exterior surface of the storage cabinet, wherein the feeding unit comprises at least one structural member to retain food in an accessible arrangement for access by an animal.

2. The portable pet station of claim 1, wherein the feeding unit attached to the portable pet station is a retractable drawer with a space for putting food or water.

3. The portable pet station of claim 1, wherein the feeding unit is attached to the mounting surface in a suspended arrangement so that a bottom surface of the feeding unit is suspended above and separated by a space from the underlying surface.

4. The portable pet station of claim 1, further comprising a catching unit positioned below the feeding unit for catching food which falls from the feeding unit to prevent the food from contacting the underlying surface.

5. The portable pet station of claim 4, wherein the catching unit directs food or other objects into an enclosed space for retention and/or disposal.

6. The portable pet station of claim 4, wherein the catching unit is retractable into the portable pet station.

7. A pet feeding station comprising:
a vertical mounting support structure;
a feeding container configured to couple to the vertical mounting support structure at a height to maintain the feeding container above and off of an underlying surface; and
a spill retention container configured to couple to the vertical mounting support structure below the feeding container, wherein the spill retention container is configured to catch substances that spill from the feeding container to substantially prevent the substances that spill from the feeding container from depositing on the underlying surface.

8. The pet feeding station of claim 7, wherein the spill retention container is suspended above the underlying surface.

9. The pet feeding station of claim 7, wherein the spill retention container is detachable from the vertical mounting support structure.

10. The pet feeding station of claim 7, wherein the spill retention container is configurable in a folded storage arrangement and an unfolded operational arrangement.

11. The pet feeding station of claim 7, further comprising a storage compartment that is at least partially defined by the vertical mounting support structure.

12. The pet feeding station of claim 11, wherein the spill retention container is at least partially retractable into the storage compartment behind the vertical mounting support structure.

13. The pet feeding station of claim 11, wherein the spill retention container comprises an inclined surface which directs the substances that spill from the feeding container into a space within the storage compartment.

14. The pet feeding station of claim 11, wherein the feeding container is at least partially retractable into the storage compartment.

15. The pet feeding station of claim 7, wherein the feeding container is detachable from the vertical mounting support structure.

16. The pet feeding station of claim 7, wherein the vertical mounting support structure comprises universal mounting locations configured to facilitate a plurality of mounting locations for mounting the feeding station to the vertical mounting support structure.

17. A modular pet station attached to a wall, the modular pet station comprising:
a plurality of receiving units, wherein each receiving unit is configured to mate with a corresponding mounting structure;
a feeding unit with a unit mounting structure configured to attach to at least one of the plurality of receiving units; and
a storage space to store pet supplies.

18. The modular pet station of claim 17, wherein the plurality of receiving units comprise recessions in a wall panel, and wherein the feeding unit is configured to hang from the recessions when attached to the receiving units so that the feeding unit is suspended above a floor below the modular pet station.
